(19) United States
(12) Patent Application Publication
(10) Pub. No.: US 2024/0354424 A1
(43) Pub. Date: Oct. 24, 2024

(54) SYSTEM AND METHODS FOR UNBIASED TRANSFORMER SOURCE CODE VULNERABILITY LEARNING WITH SEMANTIC CODE GRAPH

(71) Applicant: Board of Regents, The University of Texas System, Austin, TX (US)

(72) Inventors: Peyman Najafirad, San Antonio, TX (US); Nafis Tanveer Islam, Austin, TX (US); Gonzalo De La Torre Parra, San Antonio, TX (US)

(21) Appl. No.: 18/642,504

(22) Filed: Apr. 22, 2024

Related U.S. Application Data
(60) Provisional application No. 63/461,114, filed on Apr. 21, 2023.

(51) Int. Cl. G06F 21/57

(52) U.S. Cl. CPC G06F 21/577

(57) ABSTRACT

The present disclosure presents vulnerability code detection systems and related methods. One such method comprises executing, by a client computing device, a joint RoBERTa and graph convolutional neural network model that is configured to detect a code vulnerability attack on a computing device. The model can analyze the code structure and its connections and identify any irregularities or patterns that could be used to exploit vulnerabilities. Once the GCNN model has analyzed the code, it can provide insights to the user or system administrator about potential vulnerabilities and provide suggested actions to remediate them.

### CROSS-REFERENCE TO RELATED APPLICATION

This application claims priority to co-pending U.S. provisional application entitled, “SYSTEM AND METHODS FOR UNBIASED TRANSFORMER SOURCE CODE VULNERABILITY LEARNING WITH SEMANTIC CODE GRAPH,” having application No. 63/461,114, filed Apr. 21, 2023, which is entirely incorporated herein by reference.

### BACKGROUND

Earlier works on source code vulnerability detection prominently rely on rule-based systems. Engler et al. propose a technique to automatically extract rules from source code without prior system knowledge. One such rule would be that the declaration of spin lock must be followed by spin unlock in a code to work flawlessly. The simultaneous occurrence of these two statements takes place 99% of the time in non-vulnerable code. If these statements do not appear in pairs, it is an indication of a security flaw. Essentially, these systems work by creating a rule template for a system. Based on this hypothesis, the authors implemented six checkers, or rules, to identify bugs in code. Founded on this idea, several static analysis-based tools like Flawfinder, RATS, Cppcheck, Coverity, Infer have been proposed, built on a set of predefined rules to cover a wide range of code vulnerabilities. Since these are rule-based, the rules of these static analyzers need to be updated when a new vulnerability arises, and these tools are affected by high false-positive and false-negative rates.

The work presented by Lin et al. demonstrates how traditional machine learning (ML) methods offer an alternative to automated vulnerability discovery. In contrast to ML-based vulnerability detection, deep learning-based techniques offer additional possibilities and generalizability. VulDeepecker proposed detecting vulnerabilities using Bi-LSTM and pre-processed source code by generating Code Gadget. According to the authors, a Code Gadget is a collection of data and control dependency statements. μVulDeepecker proposed a multiclass vulnerability classification method using Bi-LSTM. They classified 40 types of vulnerability, with each type tied to a CWE. Furthermore, Russell et al. and Li et al. proposed a TextCNN based approach to detect vulnerabilities from source code. Their proposed approach considers each token as a word embedded to feed a Convolutional Neural Network for training and inference. In recent years, machine learning and deep learning techniques have also been used to detect vulnerabilities in IoT devices.

Each of these works considered source code as an analog to natural language, with some limitations in capturing the correct representation of a source code. Since source code is more structured and logical, Bilgin et al. proposed an Abstract Syntax Tree (AST) as a representation technique to detect vulnerability using machine learning. In this approach, the code is converted to an AST. Afterward, to keep the structural information of the code intact, the original AST is converted into a binary AST. The binary AST is flattened using Breadth-First Search (BFS) with a convolutional neural network (CNN) for feature generation and classification. Several studies including SySeVR, proposed a similar AST based approach with the use of LSTM, Bi-LSTM, or BGRU based methods. VulBERTa RoBERTa and used a transformer-based model to detect vulnerability from source code.

Although these methods consider using AST to capture the syntactical information of a programming language, these are eventually flattened to feed an encoder that yields the desired vulnerability semantic features. Thus, the original graph syntactics are suppressed. To address this issue, Devign proposed using and preserving the structure of Code Property Graphs (CPGs) a combination of AST, data and control flow graph, and natural code sequence by using a GGNN combined with a 1D CNN layer to generate the final embeddings for classification. Chakraborty et al. have proposed a similar method that makes use of CPGs as an input for training a GGNN. ReGVD and LineVD proposed a graph convolutional network (GCN)-based technique for vulnerability detection by creating a graph representation of the source code, and GraphCodeBERT as a tokenizer. Moreover, VELVET proposed an ensemble RoBERTa and Gated Graph Neural Network to detect vulnerabilities. Each of these techniques offer vulnerability detection at a function or file level, which is not ideal from a programmer's perspective. To address this issue, VulChecker proposed a method that identifies statements contributing to a vulnerability in order to achieve finer granularity in locating vulnerabilities.

Generating a proper graph representation of a program is significant for program analysis. Other works found in the literature have proposed an AST-based graph representation for code. Allamanis et al. make use of data flow edges with the original AST graph representation. Alon et al. and have proposed using ASTs with an attention-based network to generate program representation. TYPILUS proposed a graph-based representation similar to, with the addition of some new edges to predict variable type in a dynamic language. CodeBERT learns to represent general-purpose representations for programming languages, while GraphCodeBERT and Unixcoder proposes AST graph representation techniques for various programming language-related tasks like code-clone detection, code summarizing, and code translation.

Up to date, no one has developed a code graph representation using programming language structure (data flow, control flow, and sequential flow) combined with Poacher Flow edges to bridge the gap between dynamic and static analysis of a code to improve the performance of code vulnerability understanding.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a high-level topology of a graph convolutional network (GCN)-based framework (RoBERTa-PFGCN) for detecting, classifying vulnerabilities of source-code and furthermore provide description catered for developers in accordance with various embodiments of the present disclosure.

FIG. 2 shows an example of a possible out-of-bounds vulnerability existing in a source code in accordance with various embodiments of the present disclosure.

FIG. 3 show the overall algorithm to generate Poacher Flow edges in accordance with various embodiments of the present disclosure.

FIG. 4 shows an example of a code with the four types of edges, namely Data Flow, Control Flow, Sequential Flow and Poacher Flow in accordance with various embodiments of the present disclosure.

FIG. 5 shows an overall architecture of an exemplary system starting from source tokenization, SVG generation, training using GCN and vulnerability detection and classification in accordance with various embodiments of the present disclosure.

FIG. 6 shows 4 case study analyses to show the effectiveness of Poacher Flow edges in accordance with various embodiments of the present disclosure.

FIG. 7 shows a schematic block diagram of a computing device that can be used to implement various embodiments of the present disclosure.

### DETAILED DESCRIPTION

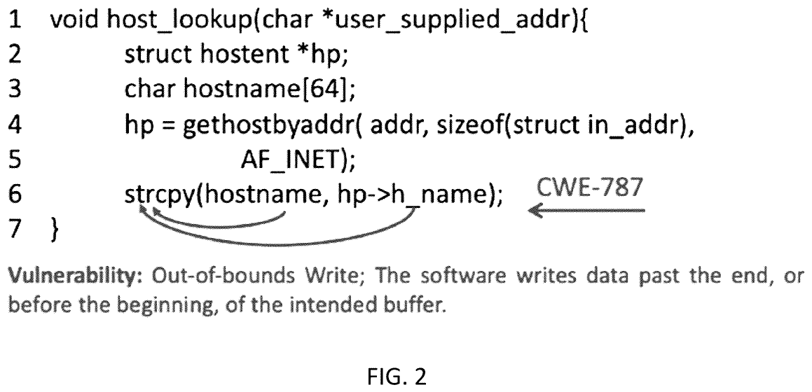

Current graph-based models like code property graphs (CPG) and AST generated by tools such as Joern provide a significant amount of information to detect vulnerabilities in a program. However, runtime vulnerabilities may arise due to the dynamic behavior of program during execution and assignments. FIG. 2 depicts a declaration of a variable hostname (line 3) and its usage (line 6). Although CPGs provide sufficient information regarding the token dependencies of a graph through data flow, there is no guarantee that the hostname in this case will not be longer than 64 bytes. Furthermore, training a transformer-based model with token sequences from source code is limited given that: 1) code follows a strict syntactic structure compared to the structures found in natural languages, 2) a code's execution time output may produce different behaviors for different input and memory states, and 3) long-range dependencies are commonly found in source code.

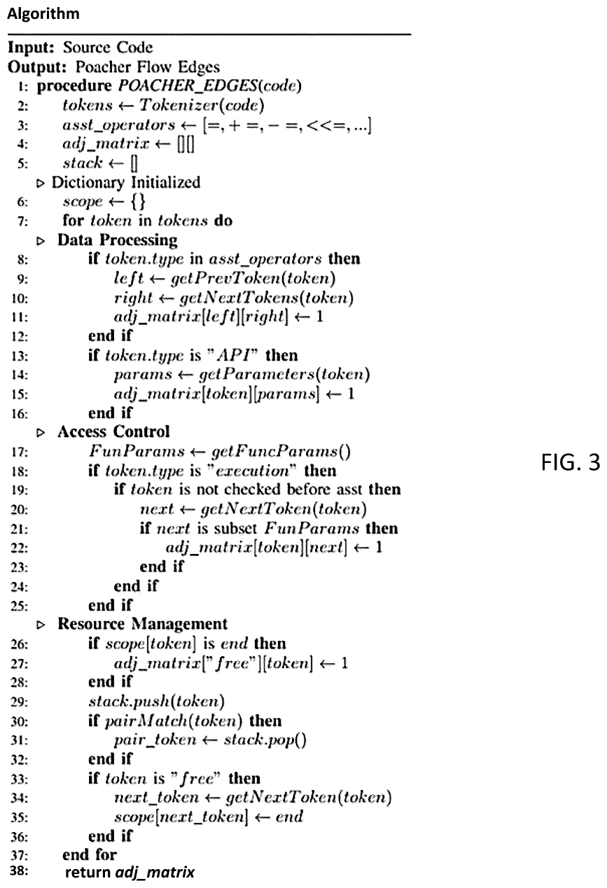

In order to address these problems, the present disclosure presents an exemplary architecture composed of three main modules, namely: 1) Semantic Vulnerability Graph (SVG) of a software program, 2) SVG Node Embedding using RoBERTa (A Robustly Optimized BERT Pretraining Approach), and 3) Multitask RoBERTa-PFGCN (Proposal Features Graph Convolutional Network). FIG. 3 provides an overall architecture of all the mentioned components.

An exemplary graph representation of a program is denoted as Semantic Vulnerability Graph (SVG). The SVG is produced via an aggregation of sequential flow edges, control flow edges, data flow edges, and poacher flow edges, a novel edge representing a vulnerability relationship that provides richer information for capturing vulnerability. Each aforementioned element is derived from the same source code. The remaining parts of this subsection provide detailed information on each component used to generate the SVG.

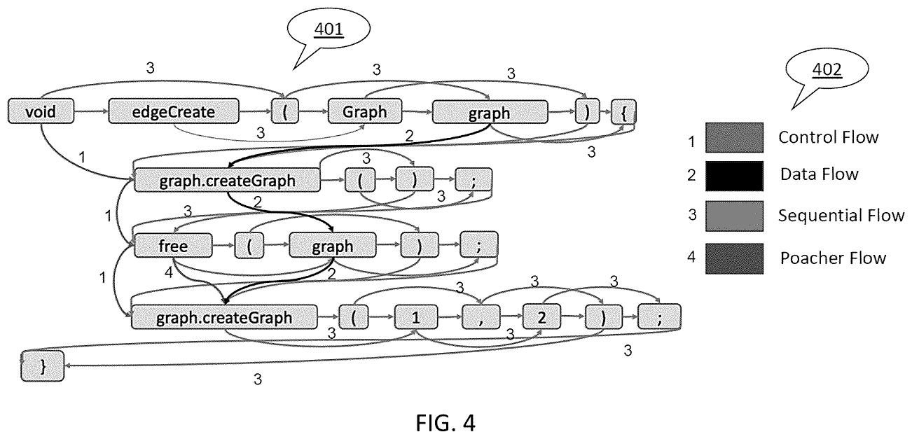

A token is a series of characters separated by spaces or punctuation marks generated by a tokenizer. Tokens may take the form of words, integers, real numbers, or a combination of these. However, tokens differ slightly when they are used in Programming Language Processing problem. In programming language, tokens may come in the form of camelCasing or snake_casing. Consider an example of the token get_item. In Natural Language Processing, the tokenizer will separate the word into two tokens, get and item. However, this combination is treated as a single token since the input is a code. Moreover, other symbols (such as parenthesis, semicolons, etc.) are considered as a single token. Each of these tokens are used as a node of the SVG. When the code is tokenized, it generates three features for each token, the original token itself, its position, and the token type. Block 401 in FIG. 4 shows a sample SVG of a program and block 402 shows the legends.

Adjacency Matrix Definition: Let us consider that a graph has an adjacency matrix A where m and n are some arbitrary nodes in the graph and edges are the connection between two nodes. Thus, the adjacency matrix is defined as:

$${A}_{m , n} = \{ \begin{matrix}1 & if & edge & exists \\ 0 & & Otherwise & \end{matrix}$$

Data Flow Edges: Data flow edges are defined as a connection between two variables dependent on each other during value assignment or modification or other usage. Some other usage of the variable may include variable definition, initialization, update, or alteration. Black edges (denoted with “2”) in block 401 of FIG. 4, shows the data flow edge.

Control Flow Edges: Illustrate the statements or operations executed throughout the program. The alternate execution of statements may be determined by conditional statements (e.g., if/while/switch). Blue edges (denoted with “1”) in block 401 of FIG. 4, shows the control flow edges.

Sequential Flow Edges: Demonstrate the syntactic relationship between the tokens of a program. Sequential flow edges show the connection of a token with its neighboring tokens. To generate this edge, an edge is created from a token with its subsequent neighboring tokens. Subsequent tokens the initial token is connected to is determined during the experiment. Gray edges (denoted with “3”) in block 401 of FIG. 4, shows the sequential flow edges.

Poacher Flow (PF) Edges: Poacher Flow edges are defined to bridge the gap between dynamic and static analysis of source code. As opposed to programming language structure (data flow, control flow, and sequential flow), PF edges are meant to identify program boundaries, potential corner cases, and external checkpoints. This is accomplished by considering the external environment context in which the program operates, including insecure input handling, the use of unsafe functions, SQL injection, or unauthorized code execution that have just recently been discovered by the CWE community in programs of a similar nature. A goal is to bridge the gap between dynamic and static analysis of a program by using PF edges. Specifically, PF edges serve as a connection between the knowledge and patterns learned stochastically from known existing vulnerability patterns using labeled data by incorporating PF edges into the machine learning training procedure. We have identified three categories of PF edges: data processing edges, access control edges, and resource management edges. These edge categories is discussed in detail in the subsections below. Additionally, algorithm in FIG. 3 presents the algorithm to generate all the elements of Poacher Flow Edges. Red (denoted with “4”) edges in block 401 of FIG. 4, shows the poacher flow edges.

Data Processing Edge: Data processing vulnerabilities are the most common types during the software development stage. For example, Out-of-Bounds Read is ranked 1 out of the top 25 vulnerabilities from 2022 CWE. Data flow edges are useful for capturing the flow of data but may not be sufficient for capturing complex data operations, such as memory pointer arithmetic. Additionally, when data manipulation involves APIs such as (strcpy, read, and write), data flow edges may fail to capture this information. The data processing edge is an extension to the existing data flow graph, which estimated the potential outcome of various mathematical operations, illegal memory issues, and unsafe API execution, pointer arithmetic. For instance, estimating divide by zero, using an uninitialized variable or using unsafe APIs like gets( ) in code.

Access Control Edge: According to the Open Web Application Security Project (OWASP), software and data integrity failures are ranked among the top ten web application security risks. These attacks take advantage of improper neutralization of special elements in web page output. While programming language structures (data flow, control flow, and sequential flow) cannot discover these vulnerabilities, access control edges can be utilized to address this issue. These edges correspond to external program calls, including application configuration settings that may not be present in the application's source code, such as passing untrusted data as arguments. Other edges include improper control over code generation and improper neutralization of special elements used in SQL commands. By performing conditional edge checks, it is possible to prevent malicious actors from passing untrusted data as arguments.

Resource Management Edge: Software vulnerability may occur when resources are not adequately managed including when a buffer copy is executed without verifying input size, incorrect array index validation, resource exhaustion, utilization of memory after an uncontrolled allocation or incomplete cleanup, or incorrect synchronization of resources within an exclusive operation such as semaphore. These scenarios can be captured by Resource management edges, which can make the classifier aware of potential inadequate resource management operation.

Combining the Edges as SVG: Each edge type is critical for finding vulnerabilities in a function. Data flow edges (black edges denoted with “2”), shown in FIG. 4 identify the flow of data for each variable; control flow edges (blue edges denoted with “1”) are responsible for the overall flow of programs; sequential flow edges (gray edges denoted with “3”) shows the syntactic relationship between the tokens of the program; lastly, Poacher Flow edges (red edges denoted with “4”)) are meant to bridge the gap between dynamic and static analysis of code by generating edges related to program boundaries, corner cases, and external checks. The SVG is constructed through the combination of data flow, control flow, sequential flow, and poacher flow edges. SVG produces richer semantic and syntactic information necessary for vulnerability detection and classification. FIG. 4 presents an example of an SVG composed of 68 edges in total, including 61 sequential flow edges (gray edges denoted with “3”), 3 data flow edges (black edges denoted with “2”), 3 control flow edges (blue edges denoted with “1”), and 1 Poacher Flow edge (red edge denoted with “4”).

SVG Node Embeddings: RoBERTa is used to generate embeddings for each token in the graph. RoBERTa was built upon BERT in which the system learns to predict purposefully masked text within unannotated language examples. RoBERTa modifies critical hyperparameters in BERT, such as deleting BERT's next-sentence pre-training target and training with significantly larger minibatch sizes and learning rates. This pre-training technique allows RoBERTa to outperform BERT in terms of the masked language modeling objective and improves the performance of subsequent tasks. However, to tokenize and initialize the node embeddings, a pre-trained variant of RoBERTa presented in GraphCodeBERT \cite{guo2020graphcodebert} is used for source code representation on code. The classifier makes use of word embeddings generated by RoBERTa and embeddings generated by a GCN model fed with heterogeneous SVG. The embeddings $E$ generated by the pre-trained RoBERTa encoder are as follows:

E=E_{R}(T)

Here, the set of tokens T where tᵢ∈T, i=1, 2, . . . , n, is the set of n tokens in SVG that are used as the input for the RoBERTa encoder [symbol] . Afterward, an adjacency matrix Aₘ, is created by using the set of tokens, T, and the connections observed between tokens following the SVG. After this step, the adjacency matrix is converted into a heterogeneous multi-edged graph G(T, E, A), where E∈R^{d} is the d dimensional embedding or feature vector of each token t in the graph. While different edge types compose the SVG, only a single adjacency matrix is used to represent all the edges where a value of 1 is set if any of the edges exist between two tokens and 0 if the edges do not exist.

Multitask RoBERTa-PFGCN: In an SVG, the existence of specific edges could serve as indicators of the existence of vulnerability. Graph convolution networks (GCN) are designed to comprehend the edge connection between two nodes. GCN is used to capture the relationship between the elements of G(T, E, A) that are essential for vulnerability detection. It is performed by generating the features used by the classifier for vulnerability detection and description. GCN is composed of two layers that aggregate vector representations of a node from its neighbors with a residual connection. GCN is formulated as follows:

$${H}^{( n + 1 )} = σ ( {W}^{n} {H}^{n} {A}^{*} )$$

where Wⁿ represents the weights at n-th layer during training and H\textsuperscript{n} is the feature representation of nodes at n-th layer. Thus, H⁽⁰⁾=E while A* is the normalized adjacency matrix. Matrix multiplication is done on Wⁿ, Hⁿ, and A*, which goes through an activation function σ (e.g., ReLU). The values in the adjacency matrix A are normalized to prevent numerical instabilities, such as vanishing or exploding gradients, that might prevent the model from converging into an optimal solution. The adjacency matrix is normalized using the method proposed by Kipf et al., which performs an inverse dot product operation for normalization. Let us consider \hat{D} as the diagonal node degree matrix such that, [symbol] =ΣⱼA [symbol] . The degree matrix of a graph is a diagonal matrix that records the degree of each vertex or the number of edges that connect each vertex to another vertex. \hat{D} also contains information about the number of edges attached to each vertex. The normalized adjacency matrix is computed as:

$${A}^{*} = {D}^{- 1} \cdot A$$

which is equivalent to:

$${A}^{*} = {D}^{- \frac{1}{2}} \cdot A \cdot {D}^{- \frac{1}{2}}$$

According to the authors in Kipf et al., the latter formula is used for better normalization.

Residual Connection: In the work presented by He et al., a residual connection is used to propagate feature representation learned from the Hⁿ layer to the next layer (H [symbol] ) by allowing gradients to pass directly from one layer to the next without encountering a vanishing or exploding gradient problem. By adding the residual connection, the model is redefined from Equation as:

$${H}^{( n + 1 )} = {H}^{n} + σ ( {W}^{n} {H}^{n} {A}^{*} )$$

After this, two dense parallel layers are added. The first layer consists of two neurons that provide the outcome for vulnerability detection. The second layer consists of 41 neurons that indicated the vulnerability description associated with the detected vulnerability.

Loss Function: Vulnerability in a real-world setting appears highly imbalanced. Therefore, non-vulnerable code highly outnumbers vulnerable code, thus a classifier is always biased toward the majority class. As a result, usual loss function like CrossEntropyLoss provides higher false-positive and false-negatives. Focal Loss is employed to rectify the class imbalances of the datasets. Without this approach, the model would learn biases towards non-vulnerable samples, drastically affecting the classification performance. The Focal Loss is denoted based on cross-entropy (CE) loss for binary classification problems as:

$${CE}_{p , y} = ( \begin{matrix}- log ( p ) & if y = 1 \\ - log ( 1 - p ) & otherwise\end{matrix} )$$

where y={0, 1} denotes the ground truth provided to the classifier during the training process and p={0, 1} is the models output probability for the class y=1, for binary classification. However, we expanded this for multitask classification as well. For convenience, probability distribution pₜ is defined as:

$${p}_{t} = \{ \begin{matrix}p & if & y = 1 \\ ( 1 - p ) & otherwise , & \end{matrix}$$

Focal Loss integrates a weighing factor α∈[0,1] and defines the mathematical expression of Focal Loss for a binary classification problem. Thus, the balanced CE loss can be rewritten as:

$$CE ( {p}_{t} ) = - α log ( {p}_{t} )$$

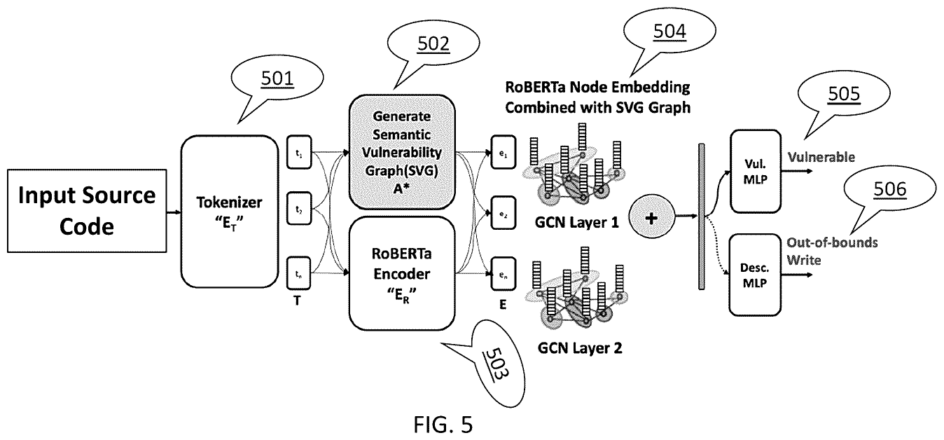

Vulnerability classification without the loss function shows that the classifier can be confused by the majority class, which also dominates the gradients. Although α balances majority and minority examples, it does not differentiate between easy (positives/negatives samples that are predicted as positive/negative) and hard examples (positives/negatives samples that are misclassified as negative/positive). To overcome this issue, a modulating factor $\delta$ is used with the cross-entropy loss to down-weight easy examples, which forces the model to be trained more precisely on hard negatives. By combining weight balance and Focal Loss, the final Focal Loss function from following equation:

$$FocalLoss ( {p}_{t} ) = - {α ( 1 - {p}_{t} )}^{δ} log ( {p}_{t} )$$

where, γ is an adjustable parameter and γ>0 FIG. 5 shows the overall architecture of the vulnerability classifier.

Complexity analysis: Algorithm in FIG. 3 provides the order of logics to create the graph. Given a sample code as input, RoBERTa Transformer is used to tokenize the code snippet to generate n tokens. Thus, the time complexity to generate n tokens is O(n). In order to generate each Poacher Flow edge, the tokens are iterated once, and all edges are created in a single pass. We generated data flow, control flow, and sequential flow edges in a single pass by iterating over $n$ tokens, hence the time complexity is O(n). As a result, the overall time complexity to generate the complete SVG is O(n). However, other graph-based analysis consists of generating an AST, which can be very time consuming. For example, for the same program with $n$ tokens, the time complexity to insert a single token into an AST is O(log n) on an average case when the tree is balanced. However, when the tree is imbalanced, the time complexity to insert a single element is O(n). Thus, the time complexity to generate an AST by inserting $n$ elements in a balanced tree is O(n log n) and in an imbalanced tree is O(n²), which is much higher than the exemplary SVG.

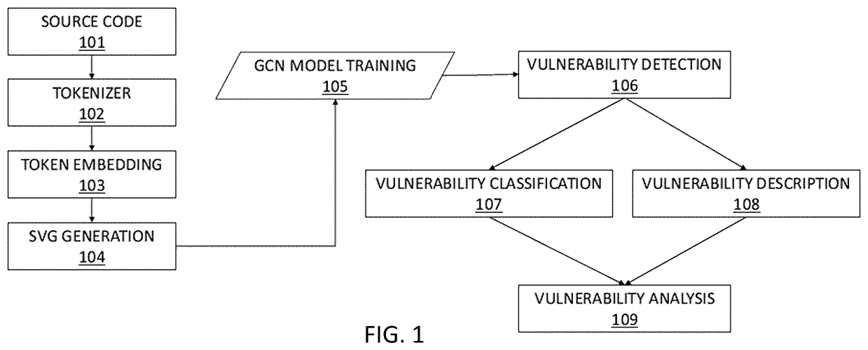

FIG. 1 illustrates a high-level topology of a vulnerability detection and classification system. In FIG. 3, blocks 101 through 109 correspond to the overall pipeline of an exemplary Graph Convolutional Network based framework for IoT source code vulnerability analysis. Block 101 represents the source code from various open source repositories from GitHub. Block 102 encompasses the extraction of the tokens of source code. In block 103, the extracted tokens are passed RoBERTa to generate embeddings. Block 104 represents the generation of SVG from the token list. Block 105 represents the training of the multitask GCN model, a main component of an exemplary source code vulnerability detection and classification using Focal Loss. Block 106 represents the trained CNN model which is used for inference for detecting code vulnerabilities. Block 107 and 108 represents the classification and description of the captured vulnerability by block 106. Finally block 109 represents the analysis of the outcome by the GCN model showing the importance of poacher flow edges.

FIG. 4 shows the complete SVG of a sample program. Each gray box shows individual tokens of the exemplary SVG. The red line (denoted with “4”) depicts a poacher flow edge, the black line (denoted with “2”) depicts data flow edges, the blue line (denoted with “1”) depicts control flow edges, and the gray line (denoted with “3”) depicts sequential flow edges. Here the vulnerability occurs when the variable graph is used after being freed. Only poacher flow edges show this relationship that a variable with a corrupt memory is being used. This edge provides the GCN with a hint that a vulnerability in source code may exist leading to a program crash.

FIG. 5 shows an Overall Architecture of an exemplary system. An exemplary classifier is divided into three parts. Initially, the input source code is converted to tokens using block 501. Then RoBERTa in block 503 layer generates embedding for each token/node of the. Then block 502 generates the SVG of the source code. Finally, the GCN layer in block 504, takes the node embedding and adjacency matrix for feature generation. Focal Loss forces the model to learn more about the minority class. The MLP layer in block 505 and 506 decides whether a function is vulnerable by leveraging the Focal Loss Function.

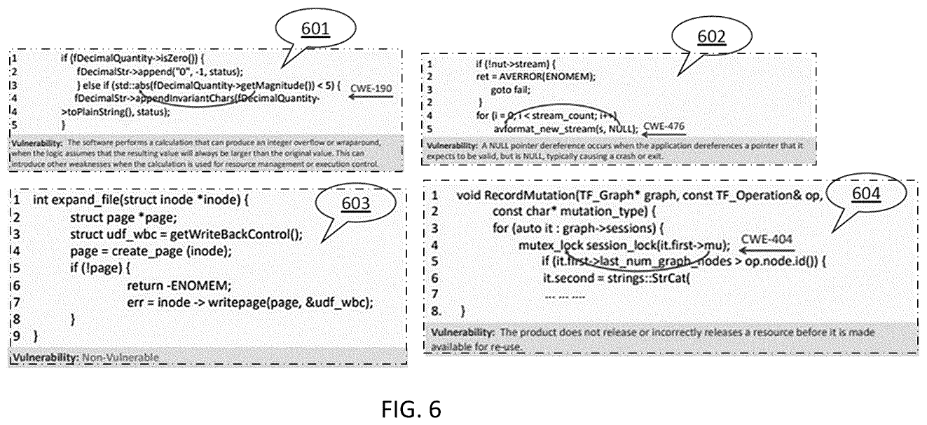

FIG. 6 shows a detailed case study analysis of the effect of poacher flow edges. Block 601 shows an example code for CWE-190, which the classifier predicted accurately. The edge shows a Poacher Flow edge that captures the Data Processing of the code. Hence, the classifier was able to detect the vulnerability with a description. Block 602 shows a sample code for CWE-476, which the classifier accurately predicted. The edge shows a Poacher Flow edge that captures the Access Control of the code. Thus, the exemplary classifier was able to detect the vulnerability with a description.

Block 603 in FIG. 6 depicts sample code for CWE-404, which the classifier accurately predicted. The edge shows a Poacher Flow edge that captures the Resource Management of the code. Thus, the classifier was able to detect the vulnerability with a description. Block 604 shows example code for CWE-476 that the classifier could not predict accurately. No poacher edges exist for this code. Hence, the model predicted it as Non-Vulnerable.

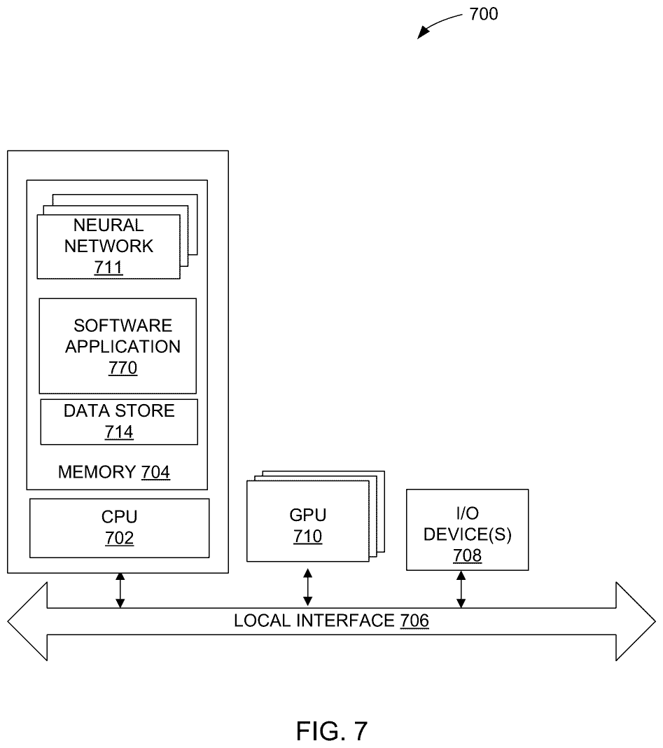

Next, FIG. 7 depicts a schematic block diagram of a computing device 700 that can be used to implement various embodiments of the present disclosure. An exemplary computing device 600 includes at least one processor circuit, for example, having a processor (CPU) 702 and a memory 704, both of which are coupled to a local interface 706, and one or more input and output (I/O) devices 708. The local interface 706 may comprise, for example, a data bus with an accompanying address/control bus or other bus structure as can be appreciated. The computing device 700 further includes Graphical Processing Unit(s) (GPU) 710 that are coupled to the local interface 706 and may utilize memory 704 and/or may have its own dedicated memory. The CPU and/or GPU(s) can perform various operations such as image enhancement, graphics rendering, image/video processing, recognition (e.g., text recognition, object recognition, feature recognition, etc.), image stabilization, machine learning, filtering, image classification, and any of the various operations described herein.

Stored in the memory 704 are both data and several components that are executable by the processor 702. In particular, stored in the memory 704 and executable by the processor 702 are code for implementing one or more neural networks 711 (e.g., Joint RoBERTa and Graph Convolutional Neural Network (GCN) model) and a software application 770 (e.g., configured to use the Joint RoBERTa and Graph Convolutional Neural Network (GCN) model to analyze code structure and connections of code running on a computer or computing device and/or identify any irregularities or patterns in the code structure that could be used to exploit vulnerabilities of the computer). Also stored in the memory 704 may be a data store 714 and other data. The data store 714 can include suggested actions to remediate computer vulnerabilities. In addition, an operating system may be stored in the memory 704 and executable by the processor 702. The I/O devices 708 may include input devices, for example but not limited to, a keyboard, mouse, etc. Furthermore, the I/O devices 708 may also include output devices, for example but not limited to, a printer, display, etc.

Certain embodiments of the present disclosure can be implemented in hardware, software, firmware, or a combination thereof. If implemented in software, the data analysis logic or functionality are implemented in software stored in a computer-readable medium, such as memory, and that is executed by a suitable instruction execution system. In the context of this document, a computer-readable medium can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

In accordance with various embodiments, an exemplary method/system of the present disclosure detects code vulnerability attacks on a computing device by executing, by a client computing device, a Joint RoBERTa and Graph Convolutional Neural Network (GCN) model; analyzing, by the GCN model, the code structure and connections of the code running on the computing device; identifying, by the GCN model, any irregularities or patterns in the code structure that could be used to exploit vulnerabilities; and/or providing insights and suggested actions, by the GCN model, to the user or system administrator to remediate the vulnerabilities. In such methods, in accordance with various embodiments, the Joint RoBERTa and GCN model may be trained on a dataset of code samples and vulnerabilities to detect code vulnerabilities on the computing device; the Joint RoBERTa and GCN model utilizes a pre-trained RoBERTa-based language model to encode text data and a graph-based model to capture the relationships between entities in the code; the GCN model is configured to continuously monitor the code running on the computing device and provide real-time feedback to the user or system administrator about potential vulnerabilities; and/or the GCN model utilizes a self-supervised learning algorithm to train the model on a dataset of code samples and vulnerabilities. In certain embodiments, such methods or systems may also perform training the graph convolutional neural network model using incoming SQL queries.

In various embodiments, for such systems and/or methods, the GCN model is configured to analyze the code structure and connections of the code running on the computing device, including smart contract and JavaScript codes; suggested insights or actions may be provided to remediate the vulnerabilities; the client computing device may comprise a mobile smartphone, an Internet of Things (IoT) device, a Virtual Reality Headset, a Bitcoin Smart Contracts, among others.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the present disclosure. All such modifications and variations are intended to be included herein within the scope of this disclosure and protected by the following claims.

Therefore, at least the following is claimed:

1. A method for detecting code vulnerability attacks on a computing device, comprising:
executing, by a client computing device, a Joint RoBERTa and Graph Convolutional Neural Network (GCN) model;
analyzing, by the GCN model, code structure and connections of code running on the computing device;
identifying, by the GCN model, any irregularities or patterns in the code structure that could be used to exploit vulnerabilities of the computing device; and
outputting insights and suggested actions, by the GCN model, to a user or system administrator to remediate the vulnerabilities.

2. The method of claim 1, wherein the Joint RoBERTa and GCN model is trained on a dataset of code samples and vulnerabilities to detect code vulnerabilities on the computing device.

3. The method of claim 1, wherein the Joint RoBERTa and GCN model utilizes a pre-trained RoBERTa-based language model to encode text data and a graph-based model to capture relationships between entities in the code.

4. The method of claim 1, wherein the GCN model is configured to continuously monitor the code running on the computing device and provide real-time feedback to the user or system administrator about potential vulnerabilities.

5. The method of claim 1, wherein the GCN model utilizes a self-supervised learning algorithm to train the model on a dataset of code samples and vulnerabilities.

6. A system for detecting code vulnerability attacks on a computing device, comprising:
at least one processor of a client computing device; and
memory configured to communicate with the at least one processor, wherein the memory stores instructions that, in response to execution by the at least one processor, cause the at least one processor to perform operations comprising:
executing, by the client computing device, a Joint RoBERTa and Graph Convolutional Neural Network (GCN) model;
analyzing, by the GCN model, code structure and connections of code running on the computing device;
identifying, by the GCN model, any irregularities or patterns in the code structure that could be used to exploit vulnerabilities of the computing device; and
outputting insights and suggested actions, by the GCN model, to a user or system administrator to remediate the vulnerabilities.

7. The system of claim 6, wherein the Joint RoBERTa and GCN model is trained on a dataset of code samples and vulnerabilities to detect code vulnerabilities on the computing device.

8. The system of claim 6, wherein the Joint RoBERTa and GCN model utilizes a pre-trained RoBERTa-based language model to encode text data and a graph-based model to capture relationships between entities in the code.

9. The system of claim 6, wherein the GCN model is configured to continuously monitor the code running on the computing device and provide real-time feedback to the user or system administrator about potential vulnerabilities.

10. The system of claim 6, wherein the GCN model utilizes a self-supervised learning algorithm to train the model on a dataset of code samples and vulnerabilities.

11. A non-transitory computer readable medium comprising machine readable instructions that, when executed by a processor of a client computing device, cause the client computing device to at least:
execute a Joint RoBERTa and Graph Convolutional Neural Network (GCN) model;
analyze, using the GCN model, code structure and connections of code running on a computing device;
identify, by the GCN model, any irregularities or patterns in the code structure that could be used to exploit vulnerabilities of the computing device; and
output insights and suggested actions, by the GCN model, to a user or system administrator to remediate the vulnerabilities.

12. The non-transitory computer readable medium of claim 11, wherein the Joint RoBERTa and GCN model is trained on a dataset of code samples and vulnerabilities to detect code vulnerabilities on the computing device.

13. The non-transitory computer readable medium of claim 11, wherein the Joint RoBERTa and GCN model utilizes a pre-trained RoBERTa-based language model to encode text data and a graph-based model to capture relationships between entities in the code.

14. The non-transitory computer readable medium of claim 11, wherein the GCN model is configured to continuously monitor the code running on the computing device and provide real-time feedback to the user or system administrator about potential vulnerabilities.

15. The non-transitory computer readable medium of claim 11, wherein the GCN model utilizes a self-supervised learning algorithm to train the model on a dataset of code samples and vulnerabilities.
